(19) United States
(12) Patent Application Publication
(10) Pub. No.: US 2015/0135157 A1
(43) Pub. Date: May 14, 2015

(54) CIRCUIT-DESIGN SIMULATION SYSTEM AND CIRCUIT-DESIGN METHOD FOR PCB

(71) Applicant: Wistron Corp, New Taipei City (TW)

(72) Inventors: Feng-Ling Lin, New Taipei City (TW); Ruey-Rong Chang, New Taipei City (TW); Wen-Jui Kuo, New Taipei City (TW)

(73) Assignee: Wistron Corp, New Taipei City (TW)

(21) Appl. No.: 14/150,613

(22) Filed: Jan. 8, 2014

(30) Foreign Application Priority Data
Nov. 14, 2013 (TW) 102141404

(51) Int. Cl. G06F 17/50

(52) U.S. Cl. CPC G06F 17/5068
USPC 716/137

(57) ABSTRACT

A circuit-design method for a PCB is provided. A first user input is obtained via a user interface of a layout tool, wherein the first user input indicates that an object of a circuit diagram of the PCB is selected in the user interface. A plurality of constraint settings corresponding to an attribute are obtained from a database according to the attribute of the object. The plurality of constraint settings are displayed in a window of the user interface. A second user input is obtained via the user interface, wherein the second user input indicates that one of the plurality of constraint settings is selected in the window. At least one constraint parameter corresponding to the selected constraint setting is assigned to the object, and a tag corresponding to the attribute of the object is attached to the object of the circuit diagram.

### CROSS REFERENCE TO RELATED APPLICATIONS

This Application claims priority of Taiwan Patent Application No. 102141404, filed on Nov, 14, 2013, the entirety of which is incorporated by reference herein.

### BACKGROUND OF THE INVENTION

1. Field of the Invention

The invention relates to a circuit-design method, and more particularly to a circuit-design method of a printed circuit board (PCB).

2. Description of the Related Art

In electronic products, especially computers, communications products, and so on, the net number of a printed circuit board (PCB) is usually in the thousands. Furthermore, in order to obtain good signal quality, the layout requirements of high-frequency signals are more stringent on PCBs.

Traditionally, after the specifications and the components of an electronic product are selected, a constraint parameter table is established manually, so as to design the PCB of the electronic product. In general, it takes 4-6 days to establish a constraint parameter table. In addition, when a circuit diagram or the constraint parameter table is modified, the circuit diagram or the constraint parameter table may not present the modification immediately and synchronously, such that the manufacturer cannot immediately check the correctness of the layout design of the PCB. Thus, it takes more time to verify the layout design of the PCB.

Therefore, a design method for a PCB is desired to standardize the management and ensure the consistency of the constraint parameters.

### BRIEF SUMMARY OF THE INVENTION

A circuit-design method and a circuit-design simulation system for a printed circuit board (PCB) are provided. An embodiment of a circuit-design method for a PCB is provided. A first user input is obtained via a user interface of a layout tool, wherein the first user input indicates that an object of a circuit diagram of the PCB is selected in the user interface. A plurality of constraint settings corresponding to an attribute are obtained from a database according to the attribute of the object. The plurality of constraint settings are displayed in a window of the user interface. A second user input is obtained via the user interface, wherein the second user input indicates that one of the plurality of constraint settings is selected in the window. At least one constraint parameter corresponding to the selected constraint setting is assigned to the object, and a tag corresponding to the attribute of the object is attached to the object of the circuit diagram.

Furthermore, an embodiment of a circuit-design simulation system for a PCB is provided. The circuit-design simulation system includes: a display, displaying the user interface of a layout tool; a storage device, including a database; and a processor coupled to the display and the storage device, obtaining a first user input and a second user input via the user interface, wherein the first user input indicates that the object of the circuit diagram of the PCB is selected in the user interface. The processor obtains a plurality of constraint settings corresponding to an attribute from the database according to the attribute of the object. The processor displays the plurality of constraint settings in a window of the user interface, and the second user input indicates that one of the plurality of constraint settings is selected in the window. The processor assigns at least one constraint parameter corresponding to the selected constraint setting to the object, and attaches a tag corresponding to the attribute of the object to the object of the circuit diagram.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a circuit-design simulation system for a printed circuit board (PCB) according to an embodiment of the invention;

FIG. 2 shows a database for storing a plurality of constraint parameters according to an embodiment of the invention;

FIG. 3 shows a circuit-design method for a PCB according to an embodiment of the invention; and

FIG. 4 shows an example illustrating a circuit diagram of the PCB displayed in a user interface according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

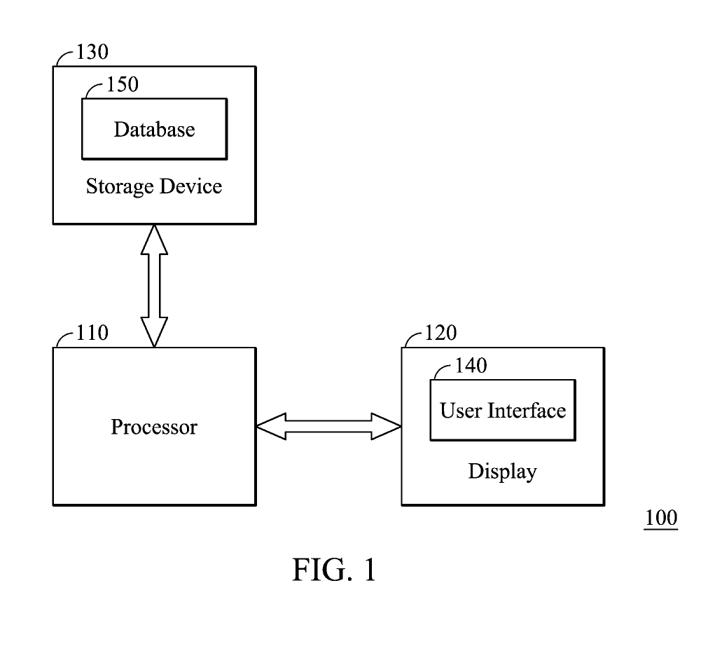

FIG. 1 shows a circuit-design simulation system 100 for a printed circuit board (PCB) according to an embodiment of the invention. The circuit-design simulation system 100 includes a processor 110, a display 120 and a storage device 130. The display 120 is used to display a user interface 140 of a layout tool, wherein the layout tool is executed by the circuit-design simulation system 100. The processor 110 is coupled to the display 120, thus a user can use to modify a PCB circuit diagram via the user interface 140 of the display 120. Furthermore, the user can select an object of the circuit diagram in the user interface 140 to attach a tag to the object, so as to assign a constraint parameter corresponding to the tag to the object. In the embodiment, a plurality of constraint parameters are stored in a database 150 of the storage device 130. Thus, the processor 110 can generate a constraint parameter table for the circuit diagram according to the tag of each object of the circuit diagram and the corresponding constraint parameters of the database 150. Therefore, the user can obtain a layout design of the PCB according to the circuit diagram and the constraint parameter table generated by the processor 110. In one embodiment, the storage device 130 is a server.

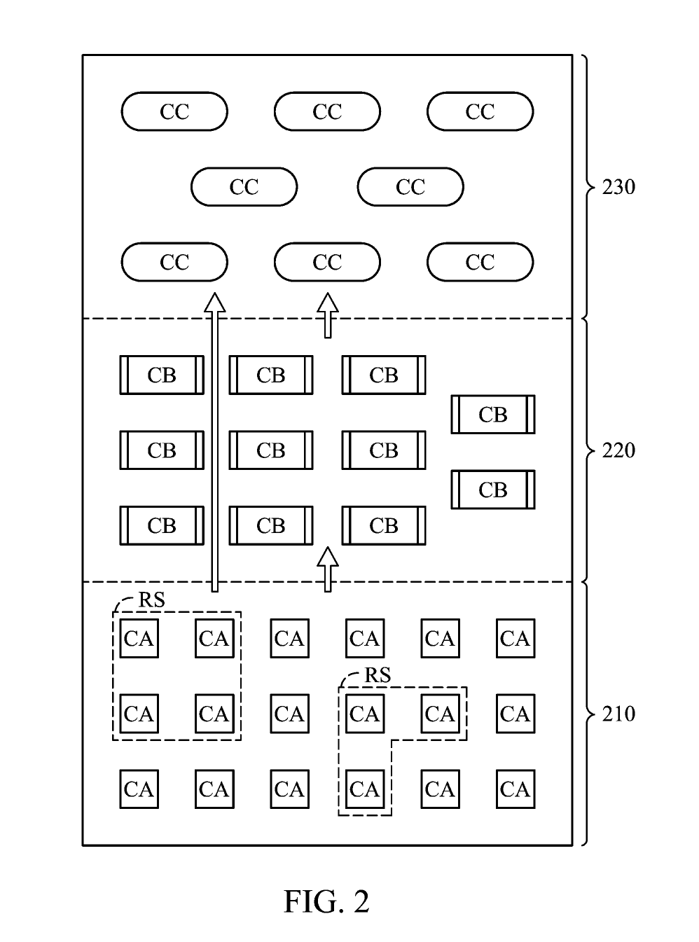

FIG. 2 shows a database 200 for storing a plurality of constraint parameters according to an embodiment of the invention. The database 200 includes a plurality of constraint settings, wherein the constraint settings are divided into a first group 210, a second group 220, and a third group 230 according to various objects of the circuit diagram. The first group 210 includes a plurality of constraint settings CA, wherein each constraint setting CA includes an individual design rule, which defines the constraint parameters of the nets or pins on the PCB. Moreover, multiple design rules can be combined to form a rule set RS, as shown in Table 1 below.

TABLE 1

| Rule | Constraint | | Constraint |
|---|---|---|---|
| Set | Setting | Design Rule | Parameter |
| RS1 | CA_1 | Assign Via | Via Name |
| | CA_2 | Current Loading | Amperage |
| | CA_3 | Operation Voltage | Voltage |
| | CA_4 | Operation Frequency | Mhz/Ghz |
| RS2 | CA_5 | Via Count | Via number |
| | CA_6 | Line Pitch | Tw/Sp |
| | CA_7 | Routing Layer Limit | List Layers |
| | CA_8 | Impedance | Zo |
| | CA_9 | DCR Value | Zo |
| RS3 | CA_10 | Diff. pair | Pair net |
| | CA_11 | Bus Class | Multiple Net |
| | CA_12 | Max. Length | Longest |
| | CA_13 | Min. Length | Shortest |
| RS4 | CA_14 | Neck Down | Thinnest |
| | | | Outgoing Line |
| | CA_15 | Sig Breakout length | Outgoing Line |
| | | | Length Limit |
| | CA_16 | Pair object | Relationship |
| | | | Between objects |
| | CA_17 | Vicinity Keep-in | Objects Within |
| | | | Range |
| RS5 | CA_18 | Isometric Within Group | Length |
| | CA_19 | Isometric Between Group | Length |
| | CA_20 | Time delay | Translated Length |
| | CA_21 | Pull R | Termin. R |
| | CA_22 | Pull C | Termin. C |
| RS6 | CA_23 | Power attribute | Power/Noise |
| | CA_24 | GND attribute | GND/Protection |
| | CA_25 | RF attribute | High Frequency |
| | | | and others |
| | CA_26 | Distance from high-speed IO | Keep out off IO |
| | CA_27 | Noise Source | 2, 4, 6 |

Furthermore, the second group 220 includes a plurality of constraint settings CB, wherein each constraint setting CB includes a plurality of design rules and/or rule sets, which defines the constraint parameters of a bus corresponding to a specific function on the PCB. Specifically, in the circuit diagram, the objects (e.g. the nets and pins) corresponding to the same function can be defined as the same constraint setting CB, wherein the constraint setting CB includes multiple constraint settings CA of the first group 210. For example, on the PCB, the nets and pins that form a PCI Express (PCIe) bus have the same constraint parameters, i.e. corresponding to the same constraint setting CB. Similarly, various standard buses (e.g. USB, UART, HDMI, SPI, I2C etc.) of the circuit diagram correspond to the individual constraint setting CB, respectively. Furthermore, the third group 230 includes a plurality of constraint settings CC, wherein each constraint setting CC includes a plurality of design rules and/or rule sets, which defines the constraint parameters corresponding to a specific device or a specific module on the PCB. Specifically, the objects (e.g. nets and pins) corresponding to the same device or module in the circuit diagram can be defined as the same constraint setting CC, wherein the constraint setting CC includes multiple constraint settings CB of the second group 220 and/or multiple constraint settings CA of the first group 210. For example, on the PCB, the objects (e.g. nets and pins) connecting to a CPU or a display port will correspond to the same constraint setting CC. Similarly, various types of devices and modules (e.g. RTC, HDMI port, power management module etc.) of the circuit diagram correspond to the individual constraint setting CC, respectively. Therefore, according to various device information and the PCB specifications, the user can define different constraint settings CA in advance, and establish the corresponding constraint settings CB and the corresponding constraint settings CC according to various requirements of each electronic product. By establishing the constraint settings CA of the first group 210 and establishing the correlations between the constraint settings CA of the first group 210, the constraint settings CB of the second group 220 and the constraint settings CC of the third group 230, the constraint parameters of the PCB are standardized. Therefore, design time and verify time are decreased, and the correct constraint parameter table is generated quickly for subsequent layout design of the PCB.

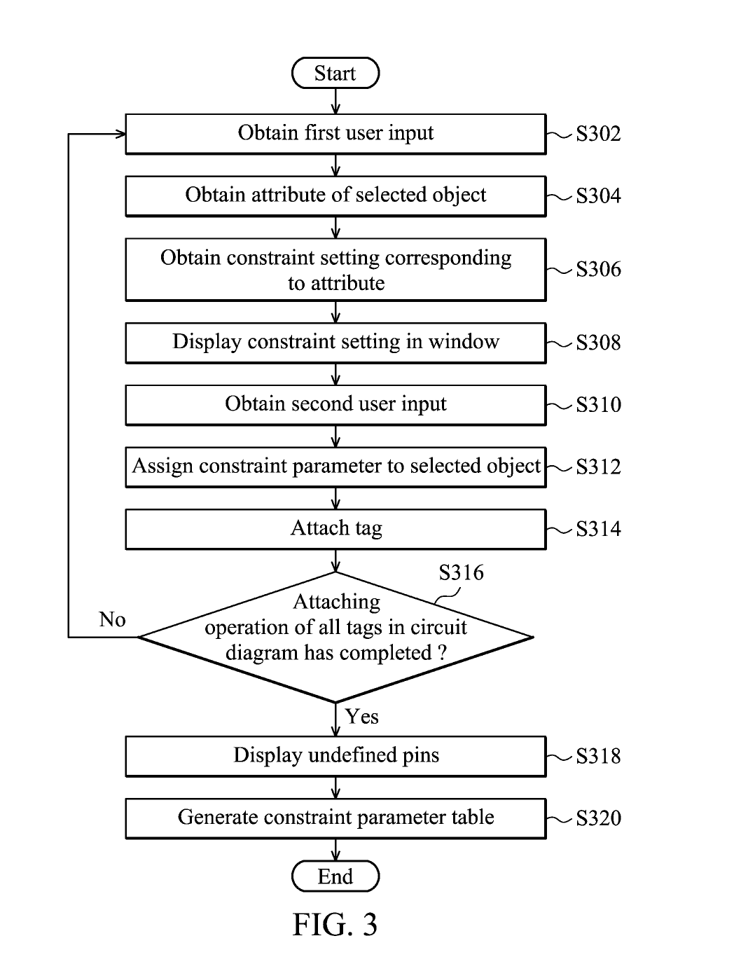

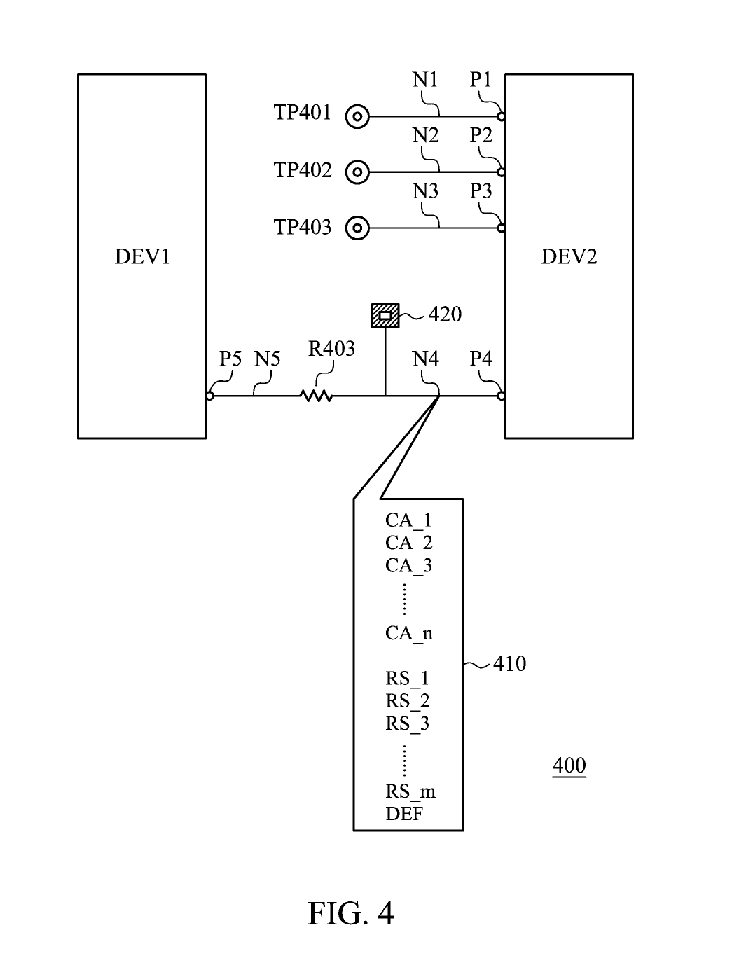

FIG. 3 shows a circuit-design method for a PCB according to an embodiment of the invention. FIG. 4 shows an example illustrating a circuit diagram 400 of the PCB displayed in a user interface according to an embodiment of the invention. In FIG. 4, a device DEV1 has a plurality of pins P1-P4. The pin P1 is coupled to a terminal point TP401 via a net N1, the pin P2 is coupled to a terminal point TP402 via a net N2, and the pin P3 is coupled to a terminal point TP403 via a net N3. The pin P4 is coupled to a terminal of a resistor R403 via a net N4, and another terminal of the resistor R403 is coupled to a pin P5 of a device DEV2 via a net N5. Referring to FIG. 1, FIG. 3 and FIG. 4, first, the circuit-design simulation system 100 displays the circuit diagram 400 of the PCB via the user interface 140 for the user to view. When the user selects any object of the circuit diagram 400, the processor 110 obtains a first user input via the user interface 140 (step S302). In the embodiment, assuming that the first user input indicates that the net N4 of the circuit diagram 400 is selected. The processor 110 determines the selected object, according to the first user input, to obtain an attribute of the selected object (e.g. net, pin, bus or device) (step S304). In the embodiment, the processor 110 will determine that the selected object is the net. In step S306, the processor 110 obtains a constraint setting corresponding to the attribute from the database 150 according to the attribute of the selected object. For example, if the attribute of the object is a net or pin, the processor 110 will obtain the constraint setting of the first group from the database 150 (e.g. the constraint setting CA of FIG. 2), which is used to define the constraint parameter of a net or a pin on the PCB. In addition, if the attribute of the object is a bus, the processor 110 will obtain the constraint setting of the second group from the database 150 (e.g. the constraint setting CB of FIG. 2), which is used to define the related constraint parameters of a bus corresponding to a specific function on the PCB. Furthermore, if the attribute of the object is a device, the processor 110 obtains the constraint setting of the third group from the database 150 (e.g. the constraint setting CC of FIG. 2), which is used to define the related constraint parameters corresponding to a specific device or a specific module on the PCB. Next, in step S308, the processor 110 displays the constraint setting corresponding to the attribute in a window of the user interface 140. For example, when the net N4 of the circuit diagram 400 of FIG. 4 is selected, the processor 110 displays the constraint settings CA_1-CA_n and the constraint settings RS_1-RS_m of the first group corresponding to the net N4 in the window 410, wherein each of the constraint settings CA_1-CA_n corresponds to a design rule, and each of the constraint settings RS_1-RS_m corresponds to a rule set formed by a plurality of the design rules. When the user selects any constraint setting in the window, the processor 110 obtains a second user input via the user interface 140 (step S310). The second user input and the first user input may be input by the same user or different users. The processor 110 assigns at least one constraint parameter corresponding to the selected constraint setting to the selected object (step S312), and attaches a tag corresponding to the attribute to the selected object (step S314). For example, assuming that the second user input indicates that the constraint setting CA_3 is selected in the window 410 of FIG. 4, the processor 110 will assign the constraint parameter (e.g. the value of the operation voltage in Table 1) corresponding to the constraint setting CA_3 to the net N4, and attach a tag 420 to the net N4 of the circuit diagram 400. In one embodiment, in order to facilitate user identification, the constraint setting of each group corresponds to a different tag. For example, the first, second, and third groups correspond to the first, second, and third tags, respectively, wherein the patterns of the first, second, and third tags have different colors or shapes. Furthermore, the user can also configure the net N4 as the constraint setting of the second group or the third group via a constraint setting DEF of the window 410. For example, the net N4 supports a UART bus, and the user can use the constraint setting DEF to establish that the net N4 has the constraint setting (e.g. CB_5 of Table 1) of the second group corresponding to the UART bus. Thus, the processor 110 will assign the constraint parameters corresponding to the constraint setting CB_5 to the net N4, and attach the tag of the second group to the net N4. Similarly, the selected object can be configured as the constraint setting of the third group, thus the processor 110 assigns the constraint parameters of the constraint setting corresponding to the third group to the selected object, and attaches the tag of the third group to the selected object. In step S316, the processor 110 determines whether the user has completed the attaching operation of all tags in the circuit diagram. If the user continues to select objects on the circuit diagram, the procedure returns to step S302, so as to attach the corresponding tag to the selected object. Moreover, if the user selects the other constraint setting of the window, the procedure returns to step S310, so as to assign at least one constraint parameter of the selected constraint setting to the selected object. If no object is selected by the user, the processor 110 will highlight and display the undefined pins (i.e. the pins without tags) in the circuit diagram (step S318). Thus, the user can further confirm whether or not the object had a tag attached. Next, in step S320, according to the attached tag of the circuit diagram and the constraint parameters of the database 150, the processor 110 generates a constraint parameter table for the circuit diagram. Thus, the user can complete the layout design of the PCB according to the constraint parameter table and the circuit diagram. Therefore, design time of the PCB is decreased and human error can be avoided.

According to the embodiments of the invention, the constraint parameter can be generated automatically by attaching the tag corresponding to the constraint parameter to the object in the circuit diagram. Specifically, PCB design is standardized by establishing the constraint setting of the first, second, and third groups and the corresponding constraint parameters, and the same objects can be linked to the same constraint parameters of the database automatically. Therefore, a mistake caused by manually generating the constraint parameter table is avoided, and debugging time is decreased for related products. Simultaneously, the objects without tags attached can also be displayed in the circuit diagram, so as to filter the omitted objects for the user. Furthermore, in the database, when the constraint parameter of the first group is modified, the processor will automatically update the constraint setting of the second group and the third group that comprise the modified constraint parameter of the first group. Therefore, it is a more flexible and consistent way to manage constraint parameters.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

1. A circuit-design method for a printed circuit board (PCB), comprising:
obtaining a first user input via a user interface of a layout tool by a processor, wherein the first user input indicates that an object of a circuit diagram of the PCB is selected in the user interface, wherein the circuit diagram is displayed in a display via the user interface;
obtaining a plurality of constraint settings corresponding to an attribute from a database according to the attribute of the object, by the processor;
displaying the plurality of constraint settings in a window of the user interface;
obtaining a second user input via the user interface by the processor, wherein the second user input indicates that one of the plurality of constraint settings is selected in the window; and
assigning at least one constraint parameter corresponding to the selected constraint setting to the object, and displaying a tag attached to the object in the circuit diagram, wherein the tag corresponds to the attribute of the object.

2. The circuit-design method as claimed in claim 1, further comprising:
generating a constraint parameter table of the circuit diagram according to the tag of the circuit diagram, wherein the constraint parameter table comprises the constraint parameter corresponding to the object.

3. The circuit-design method as claimed in claim 2, further comprising:
obtaining a layout design of the PCB according to the constraint parameter table and the circuit diagram.

4. The circuit-design method as claimed in claim 1, wherein the attribute indicates that the object is a net, a pin, a bus or a device of the circuit diagram.

5. The circuit-design method as claimed in claim 4, wherein when the attribute indicates that the object is the net or the pin of the circuit diagram, each of the constraint settings is a first constraint setting, wherein the first constraint setting comprises a design rule of the PCB, and the tag has a first pattern corresponding to the attribute.

6. The circuit-design method as claimed in claim 5, wherein when the attribute indicates that the object is the bus of the circuit diagram, each of the constraint settings is a second constraint setting, wherein the second constraint setting comprises multiple first constraint settings, and the tag has a second pattern corresponding to the attribute.

7. The circuit-design method as claimed in claim 6, wherein when the attribute indicates that the object is the device of the circuit diagram, each of the constraint settings is a third constraint setting, wherein the third constraint setting comprises multiple second constraint settings and multiple first constraint settings, and the tag has a third pattern corresponding to the attribute.

8. The circuit-design method as claimed in claim 7, wherein the first, second and third patterns have different shapes or colors.

9. The circuit-design method as claimed in claim 1, further comprising:
displaying the objects without tags attached of the circuit diagram in the user interface.

10. The circuit-design method as claimed in claim 1, wherein the constraint parameter is used to define a design rule of the vias, voltages, currents and traces of the PCB.

11. A circuit-design simulation system for a printed circuit board (PCB), comprising:
a display, displaying a user interface of a layout tool;
a storage device, comprising a database; and
a processor coupled to the display and the storage device, obtaining a first user input and a second user input via the user interface, wherein the first user input indicates that an object of a circuit diagram of the PCB is selected in the user interface;
wherein the processor obtains a plurality of constraint settings corresponding to an attribute from the database according to the attribute of the object;
wherein the processor displays the plurality of constraint settings in a window of the user interface, and the second user input indicates that one of the plurality of constraint settings is selected in the window;
wherein the processor assigns at least one constraint parameter corresponding to the selected constraint setting to the object, and displays a tag attached to the object in the circuit diagram, wherein the tag corresponds to the attribute of the object.

12. The circuit-design simulation system as claimed in claim 11, wherein the processor generates a constraint parameter table of the circuit diagram according to the tag of the circuit diagram, wherein the constraint parameter table comprises the constraint parameter corresponding to the object.

13. The circuit-design simulation system as claimed in claim 12, wherein a layout design of the PCB is obtained according to the constraint parameter table and the circuit diagram.

14. The circuit-design simulation system as claimed in claim 11, wherein the attribute indicates that the object is a net, a pin, a bus or a device of the circuit diagram.

15. The circuit-design simulation system as claimed in claim 14, wherein when the attribute indicates that the object is the net or the pin of the circuit diagram, each of the constraint settings is a first constraint setting, wherein the first constraint setting comprises a design rule of the PCB, and the tag has a first pattern corresponding to the attribute.

16. The circuit-design simulation system as claimed in claim 15, wherein when the attribute indicates that the object is the bus of the circuit diagram, each of the constraint settings is a second constraint setting, wherein the second constraint setting comprises multiple first constraint settings, and the tag has a second pattern corresponding to the attribute.

17. The circuit-design simulation system as claimed in claim 16, wherein when the attribute indicates that the object is the device of the circuit diagram, each of the constraint settings is a third constraint setting, wherein the third constraint setting comprises multiple second constraint settings and multiple first constraint settings, and the tag has a third pattern corresponding to the attribute.

18. The circuit-design simulation system as claimed in claim 17, wherein the first, second and third patterns have different shapes or colors.

19. The circuit-design simulation system as claimed in claim 11, wherein the processor displays the objects without tags attached of the circuit diagram in the user interface.

20. The circuit-design simulation system as claimed in claim 11, wherein the constraint parameter is used to define a design rule of the vias, voltages, currents and traces of the PCB.
